(19) United States
(12) Patent Application Publication
(10) Pub. No.: US 2023/0177430 A1
(43) Pub. Date: Jun. 8, 2023

(54) STREAMLINING PROJECT REQUESTS FOR INFORMATION

(71) Applicant: INTERNATIONAL BUSINESS MACHINES CORPORATION, ARMONK, NY (US)

(72) Inventors: Clement Decrop, Arlington, VA (US); Thomas Jefferson Sandridge, Tampa, FL (US); Zachary A. Silverstein, Georgetown, TX (US); Jeremy R. Fox, Georgetown, TX (US)

(21) Appl. No.: 17/457,986

(22) Filed: Dec. 7, 2021

(51) Int. Cl. G06Q 10/06; G06F 40/20

(52) U.S. Cl. CPC G06Q 10/06316; G06F 40/20

(57) ABSTRACT

According to one embodiment, a method, computer system, and computer program product for RFI streamlining is provided. The embodiment may include identifying one or more similarities between a current RFI and historical RFIs within a knowledge corpus. The embodiment may also include predicting one or more remedies to the current RFI based on the one or more identified similarities. The embodiment may further include prioritizing the current RFI among one or more open RFIs based on the one or more predicted remedies.

### BACKGROUND

The present invention relates generally to the field of computing, and more particularly to project management.

Project management relates to a temporary effort to generate a result, physical or otherwise, where multiple entities may be organized in a collaborative endeavor. Each project overseen by a project manager is unique and requires varying, yet specific requirements that correspond to the identified goal (e.g., a product, service, or result). Due to the evolving nature of industries, technological advancements, and globalization, efforts centered around projects require effective team collaboration by professionals skilled in performing specific tasks. Some projects need quick resolution with an understanding that the resolution is only temporary and improvements or upgrades will be performed over time (e.g. software development). However, other projects, typically of a longer duration, require a product that will withstand or hold up over time and, therefore, improvements to the completed product may be impractical and/or costly (e.g., highway construction).

### SUMMARY

According to embodiments, a method, computer system, and computer program product for RFI streamlining is provided. The embodiments may include identifying one or more similarities between a current RFI and historical RFIs within a knowledge corpus. The embodiments may also include predicting one or more remedies to the current RFI based on the one or more identified similarities. The embodiments may further include prioritizing the current RFI among one or more open RFIs based on the one or more predicted remedies.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a streamlined request for information process according to at least one embodiment.

FIG. 3 is a block diagram of internal and external components of computers and servers depicted in FIG. 1 according to at least one embodiment.

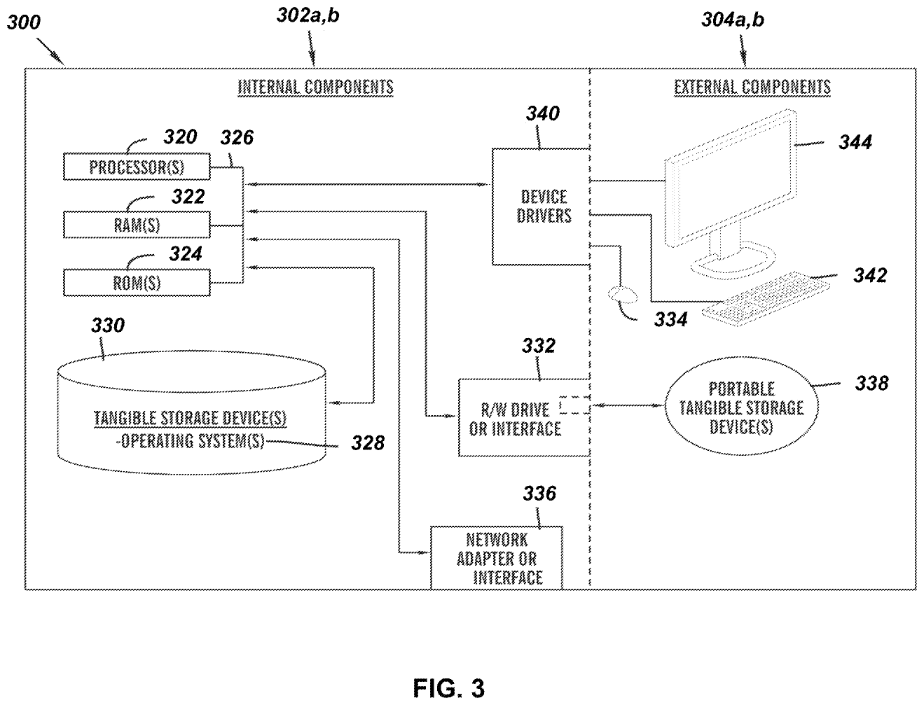

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to project management. The following described exemplary embodiments provide a system, method, and program product to, among other things, ingest historical request for information (RFI) data and current project data (e.g., schedule, costs, etc.) to actively prioritize and streamline the RFI process and present solutions to arising issues. Therefore, the present embodiment has the capacity to improve the technical field of project management by integrating objectivity into the prioritization process of RFIs as well as streamlining the prioritization process of RFIs in a practical manner regardless of the number of RFIs being considered.

As previously described, project management relates to a temporary effort to generate a result, physical or otherwise, where multiple entities may be organized in a collaborative endeavor. Each project overseen by a project manager is unique and requires varying, yet specific requirements that correspond to the identified goal (e.g., a product, service, or result). Due to the evolving nature of industries, technological advancements, and globalization, efforts centered around projects require effective team collaboration by professionals skilled in performing specific tasks. Some projects need quick resolution with an understanding that the resolution is only temporary and improvements or upgrades will be performed over time (e.g. software development). However, other projects, typically of a longer duration, require a product that will withstand or hold up over time and, therefore, improvements to the completed product may be impractical and/or costly (e.g., highway construction).

Project management, or the oversight of completing a project, involves working with many different stakeholders that each play a vital role in seeing the project to completion. For example, in a construction project, the property owner funds the project, architects and structural engineers are charged with designing a sound building, a general contractor is responsible for organizing the execution of the projection, and sub-contractors are hired by the general contractor to execute certain aspects of the project.

Throughout the project, each stakeholder, entity, or involved party must transfer information effectively and fluidly. However, such fluid communication of information may not always be present. For example, a project lead may be attempting to execute a design when incomplete or inconsistent information is encountered. During such an occurrence, the project lead may be required to complete an RFI to be submitted to the project designer so that clarity may be provided. An RFI is a request by one party involved in a project to obtain clarity of uncertainties or unknowns from another party involved in the project. Furthermore, depending on the project, an RFI may need to be cycled through different entities depending on the information needed. For example, an RFI may be submitted by a sub-contractor to a project lead for information, the project lead may need to send the RFI to a project designer for clarification, and the project designer may need to inquire with the owner for decision making.

On larger projects, a project lead may spend many hours completing RFIs for completion and return by other entities. As such, a backlog of RFIs can easily cause a project timeline to fall of schedule and delay the overall project. For example, in a construction project, a sub-contractor may not be able to complete a job until an RFI is returned. With the sub-contractor unable to complete the job, work by other sub-contractors, and the project as a whole, may come to a halt. As such, it may be advantageous to, among other things, utilize historical RFI data from previous project as well as information related to the current project to prioritize and streamline the RFI process so as to prevent unnecessary delays to the project.

According to at least one embodiment, upon an opt-in and integration with existing project management software, a knowledge corpus may be built using gathered historical data surrounding past projects and RFIs, such as scheduling information, financial information, change histories, and asset information. When an RFI for a current project is received, the RFI may be cognitively processed using cognitive analysis software, such as Watson® Compare and Comply (Watson and all Watson-based trademarks and logos are trademarks or registered trademarks of International Business Machines Corp. and/or its affiliates) to extract the core components of the RFI. Using known processing techniques such as Word2Vec and BERT, similar RFIs may be extracted from the generated knowledge corpus. The instant RFI may be modulated and manipulated through known historical optimizations based on the extracted similar RFIs. Once known historical blockers within the extracted similar RFIs are identified, the current RFI may be appropriately prioritized against other pending RFIs to ensure stoppages to the project are not encountered.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to streamline and prioritize RFIs based on historical data associated with previous projects and known blockages within the current project.

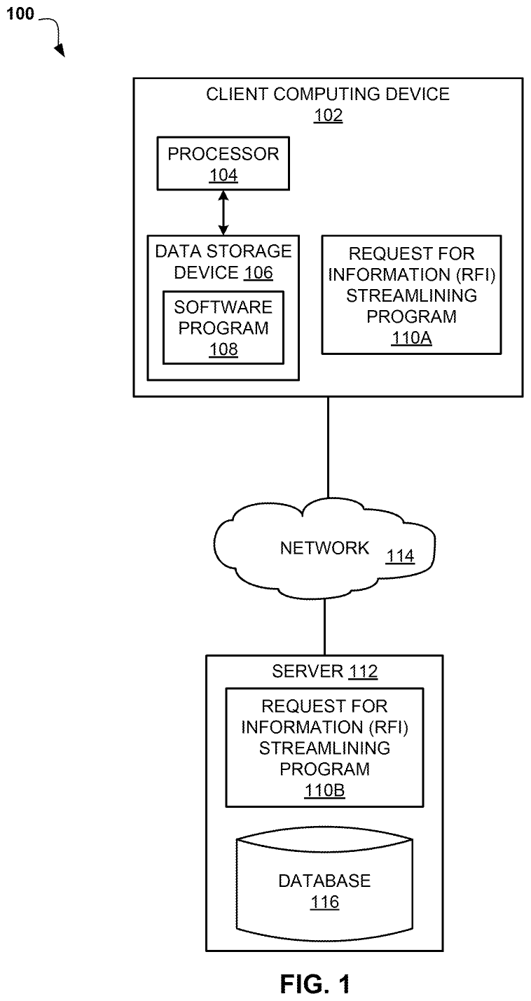

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity. Additionally, in one or more embodiments, the client computing device 102 and server 112 may each individually host a request for information (RFI) streamlining program 110A, 110B. In one or more other embodiments, the RFI streamlining program 110A, 110B may be partially hosted on both client computing device 102 and server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

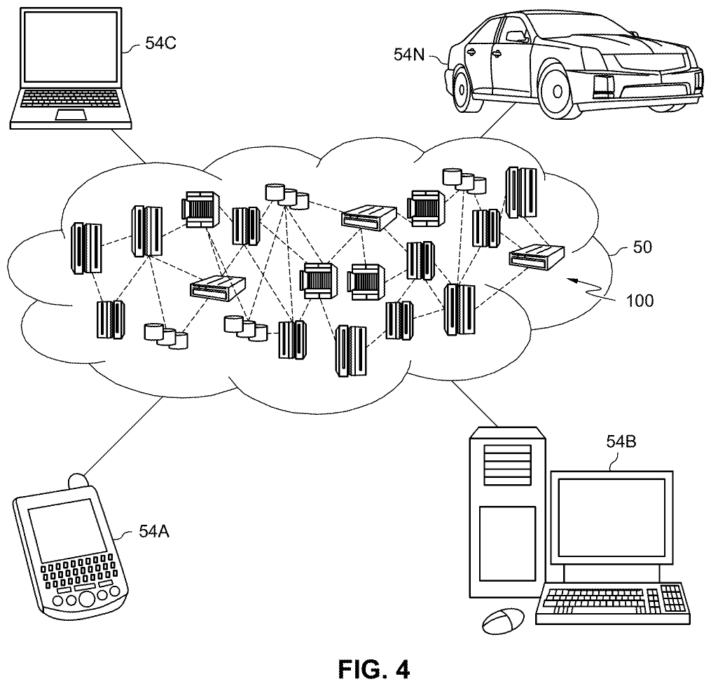

Client computing device 102 may include a processor 104 and a data storage device 106 that is enabled to host and run a software program 108 and a RFI streamlining program 110A and communicate with the server 112 via the communication network 114, in accordance with one embodiment of the invention. In one or more embodiments, client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a RFI streamlining program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

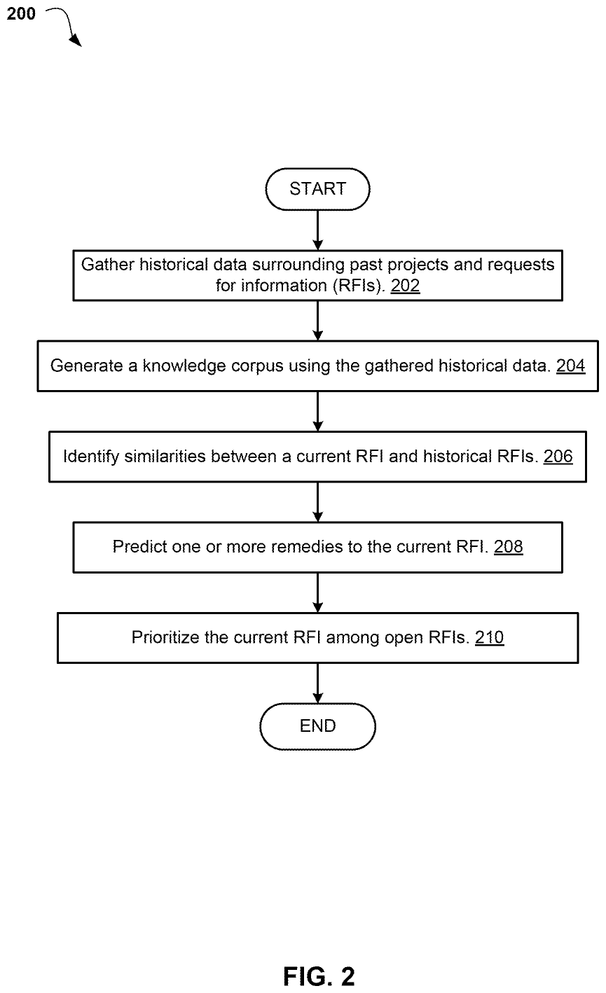

According to the present embodiment, the RFI streamlining program 110A, 110B may be capable of building a knowledge corpus from ingested historical information, such as RFIs from previous projects, scheduling items, asset information, and financial information. Once an RFI has been received in a current project, the RFI streamlining program 110A, 110B cognitively analyzes the received RFI and extracts core components of the document. Using the core components, the RFI streamlining program 110A, 110B may modulate the RFI through known optimization methods, apply clash detections, and prioritize the RFI against other pending RFIs based on a comparison to information contained in the knowledge corpus. The RFI streamlining method is explained in further detail below with respect to FIG. 2.

Referring now to FIG. 2, an operational flowchart illustrating a RFI streamlining process 200 is depicted according to at least one embodiment. At 202, the RFI streamlining program 110A, 110B gathers historical data and requests for information related to past projects. The RFI streamlining program 110A, 110B may gather myriad forms of data relating to the current and historical projects, such as, but not limited to, scheduling information (e.g., current project phase, sub-contractor schedules, forecasted schedule, change orders, etc.), project information models, financial information (e.g., billing information, material costs, change order costs, etc.), and requests for information data (e.g., date sent, responsible parties, RFI details, etc.). The RFI streamlining program 110A, 110B may gather the historical project data from a repository of stored project data, such as database 116. In at least one other embodiment, the RFI streamlining program 110A, 110B may utilize document analysis software, such as IBM® Business Automation Content Analyzer (IBM and all IBM-based trademarks and logos are trademarks or registered trademarks of International Business Machines Corp. and/or its affiliates), to extract information from stored historical project-related documents.

In at least one embodiment, before gathering historical data, the RFI streamlining program 110A, 110B may integrate an opt-in procedure presented to a user upon first installation. In at least one other embodiment, the RFI streamlining program 110A, 110B may integrate the opt-in procedure with an existing project management software, such as software program 108. The integration may be applied on the project level requiring an opt-in for each project with which the user wishes to use the RFI streamlining program 110A, 110B or at the enterprise level if multiple project use is desired.

Then, at 204, the RFI streamlining program 110A, 110B generates a knowledge corpus using historical data. Once gathered, the RFI streamlining program 110A, 110B may utilize the historical project data to generate a knowledge corpus of previous RFIs for the current project and historical projects. The RFI streamlining program 110A, 110B may store the historical project data as an index for RFIs in a JSON/XML format that incorporates the historical data gathered in step 202. For example, an entry to the knowledge corpus may appear as {Company: XX, Project: YY, RFI #: 12412, RFI details: Clashing at location ZZ, Cost: $4,509.83, Date Sent: Apr. 3, 2020, Project Progress: WW %, Time to Resolve: 24 days, Urgency: Low}.

Next, at 206, the RFI streamlining program 110A, 110B identifies similarities between an existing RFI and historical RFIs. The RFI streamlining program 110A, 110B may use various methods to analyze different parts of RFIs indexed in the knowledge base to identify similarities between the indexed RFIs and the existing, or current, RFI. For text fields, various natural language processing (NLP) techniques may be used to provide contextualized similarities between the existing RFI and the indexed RFIs in the knowledge based. Such NLP techniques may include, but are not limited to, Bag of Words (BOW), Word2Vec, BERT, and cosine similarity. For numerical fields, the RFI streamlining program 110A, 110B may develop correlations using classic regression analytics. Additionally, the RFI streamlining program 110A, 110B may utilize a trained discovery model, such as IBM® Watson® Compare and Comply, a rules engine, or a recurrent neural network.

The RFI streamlining program 110A, 110B may also utilize relevance scoring methods to develop an equation by assigning each field a different weight. The formula for performing the relevance scoring for a number of fields and weighted correlations may be represented as:

Relevance Score between RFIs=Project_Site_Weight*Project_Site_Weight_Correlation+Project_Progress_Weight*Project_Progress_Weight_Correlation+RFI_Outcome*RFI_Outcome_Correlation+ . . . N_parameter*N_parameter

Accordingly, the formula may be filtered to only take into account RFIs that are relevant to a specific project and disregard other RFIs without relevance. For example, an RFI requesting information on ductwork spacing may disregard historical RFIs relating to foundation design.

Then, at 208, the RFI streamlining program 110A, 110B predicts one or more remedies for the existing RFI. Based on the resolution of historical RFIs, the RFI streamlining program 110A, 110B may predict and provide a set of responses to the current RFI. Most commonly the basis for RFIs are missing or conflicting information. For missing information, the RFI streamlining program 110A, 110B may extract information within the current RFIs that is potentially missing and provide a correction based on the historical RFIs. For example, if a project design is missing specific parameters for a particular aspect that prevents a team member from completing their respective portion of the project, the RFI streamlining program 110A, 110B may search the knowledge corpus for similar historical project RFIs and provide one or more possible parameter values to complete the missing information.

For conflicting, or clashing information, the RFI streamlining program 110A, 110B may identify the specific parameters that are in conflict in the current RFI and provide possible resolutions for the conflicts based on the historical RFIs in the knowledge corpus. For example, if a construction project design calls for slab-to-slab height of 8′4″ but also calls for an 8′ ceiling and 10″ for duct spacing, a discrepancy in need of resolution exists. The RFI streamlining program 110A, 110B may prompt the user to select the preferred resolution (e.g., increase the slab-to-slab height, decrease the ceiling height, or decrease the duct space). In at least one embodiment, the RFI streamlining program 110A, 110B may sort the resolutions based on previously selected resolutions in the historical projects of the knowledge base. For example, if the knowledge base showed that the preferred resolution to a slab-to-slab height conflict was to decrease the ceiling height, the RFI streamlining program 110A, 110B would display that option first in a ranking of resolutions or place an indicator beside the preferred resolution.

In at least one embodiment, before prompting an answer from the user, the RFI streamlining program 110A, 110B may verify the identified resolutions from the knowledge corpus for missing or conflicting information in the current RFI using an known BIM model to ensure that conflicts or clashes will not remain if a specific resolution is selected by the user. For example, if a specific parameter is selected from a list of possible resolution parameters in response to an RFI based off of missing information, the RFI streamlining program 110A, 110B may analyze each resolution with a BIM model to ensure each possible resolution does not create a conflict with other parameters in the project design documents.

In another embodiment, the RFI streamlining program 110A, 110B may only display possible resolutions to the missing or conflicting information that is identified as being statistically sure to resolve the issue of missing or conflicting information. This determination may be based on the knowledge corpus containing a preconfigured number of historical RFI data to generate a confidence score satisfying a threshold value. Similarly, the RFI streamlining program 110A, 110B may determine a possible resolution to the current RFI based on calculating a relevance score, based upon the a total number of historical RFIs and/or similar information in the knowledge corpus, that satisfies a threshold value.

Next, at 210, the RFI streamlining program 110A, 110B prioritizes the current RFI among other open RFIs. In order to have the current RFI properly addressed by the entity from which information is needed to complete the RFI in an optimal manner, the RFI streamlining program 110A, 110B may properly prioritize the current RFI among all open RFIs awaiting completion. The RFI streamlining program 110A, 110B performs the prioritization through calculation of a prioritization score for each open RFI, including the current RFI, based on various factors each of which may hold a different weight. The various factors may include, but are not limited to, return on investment, importance based on current progress, time to complete the respective RFI, and predicted solution.

For return on investment, the RFI streamlining program 110A, 110B may predict a return on investment value for each open RFI through a comparison with previous return on investments from similar RFIs identified in step 206. The RFI streamlining program 110A, 110B may analyze time spent to resolve the RFI, the number of individuals involved, and other variables gathered in the data collection phase.

For importance based on the current progress, the RFI streamlining program 110A, 110B may determine the urgency of the RFI in relation to the current completion of the project. For example, if the RFI is requesting information critical for one entity to complete a key phase of the project, that RFI might receive a higher importance to the current project progress than an RFI requesting minor information for an ancillary element of the overall project.

For time to complete the RFI, the RFI streamlining program 110A, 110B may compare the current RFI to the similar RFIs identified from the knowledge corpus in step 206 and how long each similar RFI took to complete. Similarly, the RFI streamlining program 110A, 110B may analyze the complexity of the information being sought in the RFI and the number of individuals from whom information is sought when determining the length of time to complete. For example, if an open RFI requires information from multiple entities, it will likely require more time to complete than an open RFI requiring information from only one individual. Similarly, if an open RFI requires a great deal of information from a single individual, which may require significant research, more time may be required than for an RFI requiring minimal information from multiple individuals.

For solution prediction, the RFI streamlining program 110A, 110B may be capable of identifying that an RFI requires minimal time and/or effort to complete. Similarly, the RFI streamlining program 110A, 110B may identify that a single solution to the RFI is available. Under either circumstance, the RFI streamlining program 110A, 110B may tag the RFI accordingly and prioritize the RFI over other RFIs that may require more time and attention. For example, an RFI that the RFI streamlining program 110A, 110B determines only requires five minutes of attention by a developer may be assigned a “quick fix” tag and given a priority over all other RFIs due to the RFI's ability to be completed expeditiously.

In at least one embodiment, the RFI streamlining program 110A, 110B may update the prioritization score in real-time as prompted questions within the open RFI are answered and additional details related to the RFI are collected. The RFI streamlining program 110A, 110B may analyze communications between entities (e.g., RFI requesting entities and RFI completing entities) using natural language processing and/or natural language understanding techniques, documents, diagrams, and photographs may be analyzed by leveraging image analysis techniques, and audio communications (e.g., telephone calls, internet-based audio communications, and web conferences) may be analyzed using speech-to-text and natural language processing and natural language understanding techniques to collect information related to the RFI useful in enhancing the knowledge corpus. For example, multiple communications may take place between the party requesting clarification in the RFI and the entity possessing the needed information so as to ensure accurate information is provided and a final solution to the RFI is settled upon. Enhancing the knowledge corpus in such a way greatly improves the accuracy of identifying similarities between open RFIs and historical RFIs as described in step 206.

In at least one embodiment, the RFI streamlining program 110A, 110B may also update the knowledge corpus with RFI completion information. For example, information related to RFI outcome and method of correcting discrepancies or omissions may be appended to the appropriate areas of the knowledge corpus generated in step 204. The RFI streamlining program 110A, 110B may also record the prioritization score calculated for each RFI when updating the knowledge corpus based on manual and automatic feedback, which further enhances accuracy when calculating future prioritization scores.

It may be appreciated that FIG. 2 provides only an illustration of one implementation and do not imply any limitations with regard to how different embodiments may be implemented. Many modifications to the depicted environments may be made based on design and implementation requirements. In at least one embodiment, for physical projects, the RFI streamlining program 110A, 110B may utilize image recognition to identify project progress, which can be used in turn to update the existing RFI schedule. For example, during building construction, camera footage from an unmanned aerial vehicle may be captured to identify construction progress and update prioritization of open RFIs based on those open RFIs that will most impact the project in light of the captured footage.

In at least one other embodiment, the project may be an online learning environment where students submit questions regarding lessons. In such an environment, educators may attempt to prioritize student questions based on urgency versus importance to the lesson plan. The RFI streamlining program 110A, 110B may be used to dynamically mine data from the submitted questions (e.g., through natural language processing, natural language understanding, image analysis, speech-to-text, etc.) to prioritize the questions presented to the educator in a manner that the most important task (e.g., student question) would be presented first. For example, a student asking about the relation of the current topic to a previously discussed topic may be deemed more important than a student asking how much more time remains in the current lesson). Similarly, in the same scenario, the RFI streamlining program 110A, 110B may be capable of identifying that a majority of questions relate to a specific topic and the educator's lesson plan may be reprioritized so as to introduce the specific topic that addresses student questions earlier than the educator had originally planned. In such a situation, a manual override may be implemented to allow for an original plan to be maintained.

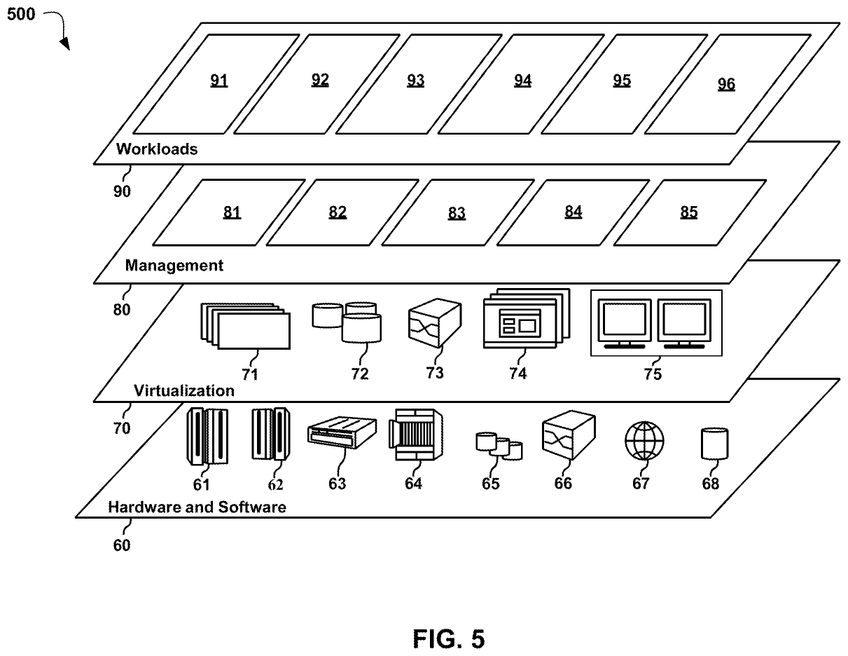

FIG. 5 is a block diagram 500 of internal and external components of the client computing device 102 and the server 112 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 502 a,b and external components 504 a,b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the software program 108 and the RFI streamlining program 110A in the client computing device 102 and the RFI streamlining program 110B in the server 112 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502 a,b also includes a RAY drive or interface 532 to read from and write to one or more portable computer-readable tangible storage devices 538 such as a CD-ROM, DVD, memory stick, magnetic tape, magnetic disk, optical disk or semiconductor storage device. A software program, such as the RFI streamlining program 110A, 110B, can be stored on one or more of the respective portable computer-readable tangible storage devices 538, read via the respective R/W drive or interface 532, and loaded into the respective hard drive 530.

Each set of internal components 502 a,b also includes network adapters or interfaces 536 such as a TCP/IP adapter cards, wireless Wi-Fi interface cards, or 3G or 4G wireless interface cards or other wired or wireless communication links. The software program 108 and the RFI streamlining program 110A in the client computing device 102 and the RFI streamlining program 110B in the server 112 can be downloaded to the client computing device 102 and the server 112 from an external computer via a network (for example, the Internet, a local area network or other, wide area network) and respective network adapters or interfaces 536. From the network adapters or interfaces 536, the software program 108 and the RFI streamlining program 110A in the client computing device 102 and the RFI streamlining program 110B in the server 112 are loaded into the respective hard drive 530. The network may comprise copper wires, optical fibers, wireless transmission, routers, firewalls, switches, gateway computers and/or edge servers.

Each of the sets of external components 504 a,b can include a computer display monitor 544, a keyboard 542, and a computer mouse 534. External components 504 a,b can also include touch screens, virtual keyboards, touch pads, pointing devices, and other human interface devices. Each of the sets of internal components 502 a,b also includes device drivers 540 to interface to computer display monitor 544, keyboard 542, and computer mouse 534. The device drivers 540, R/W drive or interface 532, and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

Referring now to FIG. 5, a set of functional abstraction layers 700 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and RFI streamlining 96. RFI streamlining 96 may relate to prioritizing an open RFI among other open RFIs based on similarities between the open RFI and historical RFIs in a knowledge corpus.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A processor-implemented method, the method comprising:
gathering historical data related to one or more past physical projects and a current physical project stored within one or more digital repositories; and
generating the knowledge corpus as an index for RFIs in a JSON format using the gathered historical data;
identifying one or more contextual similarities between a current request for information (RFI) and historical RFIs within a knowledge corpus;
predicting one or more remedies to the current RFI based on the one or more identified contextual similarities;
prioritizing the current RFI among one or more open RFIs based on the one or more predicted remedies;
updating the prioritization score for the current RFI and each open RFI as information is supplemented to each respective RFI; and
updating the knowledge corpus for improved accuracy through analysis of written communications using natural language processing and/or natural language understanding techniques, audio communications through speech-to-text and natural language processing and/or natural language understanding techniques, and visual communications through image analysis of project documents, project site diagrams, and project site images.

2. (canceled)

3. The method of claim 1, wherein the one or more contextual similarities are identified using natural language processing techniques, and wherein the natural language processing techniques are selected from a group consisting of Bag of Words, Word2Vec, Bidirectional Encoder Representations from Transformers (BERT), and cosine similarity.

4. The method of claim 1, wherein a type of the one or more remedies is missing information or conflicting information.

5. The method of claim 1, wherein prioritizing the current RFI further comprises:
calculating a prioritization score for the current RFI and each open RFI based on various factors, wherein the various factors are selected from a group consisting of return on investment, importance based on current progress, time to complete the respective RFI, and predicted solution; and
sorting the current RFI and each open RFI based on the calculated prioritization score.

6. The method of claim 2, wherein the historical data is selected from a group consisting of requests for information data, scheduling items, asset information, and financial information.

7. The method of claim 6, wherein the scheduling items is selected from a group consisting of current project phase, sub-contractor schedules, forecasted schedule, and change orders, and wherein the financial information is selected from a group consisting of billing information, material costs, and change order costs, and the request for information data is selected from a group consisting of date sent, responsible parties, and RFI details.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
gathering historical data related to one or more past physical projects and a current physical project stored within one or more digital repositories;
generating the knowledge corpus as an index for RFIs in a JSON format using the gathered historical data;
identifying one or more contextual similarities between a current request for information (RFI) and historical RFIs within a knowledge corpus;
predicting one or more remedies to the current RFI based on the one or more identified contextual similarities;
prioritizing the current RFI among one or more open RFIs based on the one or more predicted remedies;
updating the prioritization score for the current RFI and each open RFI as information is supplemented to each respective RFI; and
updating the knowledge corpus for improved accuracy through analysis of written communications using natural language processing and/or natural language understanding techniques, audio communications through speech-to-text and natural language processing and/or natural language understanding techniques, and visual communications through image analysis of project documents, project site diagrams, and project site images.

9. (canceled)

10. The computer system of claim 8, wherein the one or more contextual similarities are identified using natural language processing techniques, and wherein the natural language processing techniques are selected from a group consisting of Bag of Words, Word2Vec, Bidirectional Encoder Representations from Transformers (BERT), and cosine similarity.

11. The computer system of claim 8, wherein a type of the one or more remedies is missing information or conflicting information.

12. The computer system of claim 8, wherein prioritizing the current RFI further comprises:
calculating a prioritization score for the current RFI and each open RFI based on various factors, wherein the various factors are selected from a group consisting of return on investment, importance based on current progress, time to complete the respective RFI, and predicted solution; and
sorting the current RFI and each open RFI based on the calculated prioritization score.

13. The computer system of claim 9, wherein the historical data is selected from a group consisting of requests for information data, scheduling items, asset information, and financial information.

14. The computer system of claim 13, wherein the scheduling items is selected from a group consisting of current project phase, sub-contractor schedules, forecasted schedule, and change orders, and wherein the financial information is selected from a group consisting of billing information, material costs, and change order costs, and the request for information data is selected from a group consisting of date sent, responsible parties, and RFI details.

15. A computer program product, the computer program product comprising:
one or more computer-readable tangible storage medium and program instructions stored on at least one of the one or more tangible storage medium, the program instructions executable by a processor capable of performing a method, the method comprising:
gathering historical data related to one or more past physical projects and a current physical project stored within one or more digital repositories;
generating the knowledge corpus as an index for RFIs in a JSON format using the gathered historical data;
identifying one or more contextual similarities between a current request for information (RFI) and historical RFIs within a knowledge corpus;
predicting one or more remedies to the current RFI based on the one or more identified contextual similarities;
prioritizing the current RFI among one or more open RFIs based on the one or more predicted remedies;
updating the prioritization score for the current RFI and each open RFI as information is supplemented to each respective RFI; and
updating the knowledge corpus for improved accuracy through analysis of written communications using natural language processing and/or natural language understanding techniques, audio communications through speech-to-text and natural language processing and/or natural language understanding techniques, and visual communications through image analysis of project documents, project site diagrams, and project site images.

16. (canceled)

17. The computer program product of claim 15, wherein the one or more contextual similarities are identified using natural language processing techniques, and wherein the natural language processing techniques are selected from a group consisting of Bag of Words, Word2Vec, Bidirectional Encoder Representations from Transformers (BERT), and cosine similarity.

18. The computer program product of claim 15, wherein a type of the one or more remedies is missing information or conflicting information.

19. The computer program product of claim 15, wherein prioritizing the current RFI further comprises:
calculating a prioritization score for the current RFI and each open RFI based on various factors, wherein the various factors are selected from a group consisting of return on investment, importance based on current progress, time to complete the respective RFI, and predicted solution; and
sorting the current RFI and each open RFI based on the calculated prioritization score.

20. The computer program product of claim 16, wherein the historical data is selected from a group consisting of requests for information data, scheduling items, asset information, and financial information.
